(19) United States
(12) Patent Application Publication
(10) Pub. No.: US 2026/0123579 A1
(43) Pub. Date: May 7, 2026

(54) NON-CROP AREA DETECTION AND AUTOMATED CONTROL

(71) Applicant: Deere & Company, Moline, IL (US)

(72) Inventors: Nicholas C. BALTZ, Port Byron, IL (US); Cody W. BEST, Silvis, IL (US); Tessa N. POTTEBAUM, Waukee, IA (US); Adam J. ROYAL, Urbandale, IA (US)

(21) Appl. No.: 18/934,963

(22) Filed: Nov. 1, 2024

(51) Int. Cl. A01D 41/127; A01D 41/14; G06V 20/10; G06V 20/56

(52) U.S. Cl. CPC A01D 41/1274; A01D 41/141; G06V 20/188; G06V 20/56

(57) ABSTRACT

A control system detects that a harvester is approaching an entry boundary of a passable non-crop area. A control signal is generated to control the harvester as the harvester passes through the passable non-crop area. The control signal may be generated in response to detection of the harvester crossing the entry boundary. The control system detects when the harvester crosses an exit boundary of the passable non-crop area and generates the control signal to control the harvester in response to the harvester crossing the exit boundary.

### FIELD OF THE DESCRIPTION

The present descriptions relate to mobile agricultural machines. More specifically, the present description relates to mobile agricultural harvesting machines configured to harvest at a field.

### BACKGROUND

There are a wide variety of different mobile agricultural machines. One such mobile agricultural machine is a mobile agricultural harvesting machine. The mobile agricultural harvesting machine can include a header, such as a corn header, a grain header, a draper header, an auger header, etc.

It is not uncommon, when performing harvesting operations in a field, for an agricultural harvester to approach different types of passable non-crop areas in the field. By passable it is meant that the harvester can drive through or pass through the non-crop area during the harvesting operation. For instance, the agricultural harvester may approach a passable waterway where no crop is growing. Such waterways may be areas in a field used to drain water from other areas in the field. In addition, a field may have a field road. A field road extends through the field where no crop is planted. During harvesting, the harvester may encounter a field road as well. There are also other types of passable non-crop areas in fields that a harvester may encounter.

Discussion above is merely provided for general background information and is not intended to be used as an aid in determining the scope of the claimed subject matter.

### SUMMARY

A control system detects that a harvester is approaching an entry boundary of a passable non-crop area. A control signal is generated to control the harvester as the harvester passes through the passable non-crop area, based on detection of the harvester crossing the entry boundary. The control system detects when the harvester crosses an exit boundary of the passable non-crop area and generates a control signal to control the harvester in response to the harvester crossing the exit boundary.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial pictorial, partial block diagram of a combine harvester in an agricultural system.

FIGS. 2, 3, and 4 are pictorial illustrations of a combine harvester traversing a non-crop area.

FIG. 5 is a block diagram showing one example of a non-crop area control system.

FIGS. 6A and 6B (collectively referred to herein as FIG. 6) is a flow diagram showing one example of the operation of a harvester control system.

FIG. 7 is a block diagram showing one example of an agricultural system deployed in a remote server environment.

FIG. 8 is a block diagram of one example of a mobile device that can be used in architectures and systems shown in other figures.

FIG. 9 is one example of a mobile device that can be used in architectures and systems shown in other figures.

FIG. 10 shows one example of a mobile device that can be used in architectures and systems shown in other figures.

FIG. 11 is a block diagram showing one example of a computing environment that can be used in architectures and systems shown in other figures.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, agricultural harvesters, while performing harvesting operation in a field, may encounter non—crop areas in the field. Such non—crop areas may be passable areas where the agricultural harvester passes through the non—crop area then continue the harvesting operation on the other side of the non—crop area. Examples of such passable non—crop areas may include such things as waterways, field roads, etc.

An operator of an agricultural harvester may wish to change operational settings of the agricultural harvester while the agricultural harvester is passing through the non—crop area. For instance, the agricultural harvester may be performing the harvesting operation in the field at a first ground speed that is suitable for harvesting. However, the harvester may be able to travel more quickly through the non—crop area because the agricultural harvester will not be harvesting. Thus, an operator may wish to increase the ground speed of the agricultural harvester as the agricultural harvester passes through the non—crop area and then again reduced speed once the agricultural harvester exits the non—crop area and again commences harvesting. In another example, the height of a header on the agricultural harvester may be set at a first height during the harvesting operation. However, because of the terrain in the non—crop area or for other reasons, the operator may wish to change the header height as the agricultural harvester travels through the non—crop area.

It can be cumbersome, time tiring, and error-prone, for the operator to attempt to manually observe when the agricultural harvester enters a passable non—crop area, and then manipulate settings as the agricultural harvester travel through the non—crop area, and then again monitor when the agricultural harvester exits the non—crop area and to change settings again to resume harvesting.

Thus, in accordance with one example, the present description describes a system that automatically detects when the agricultural harvester is approaching an entry boundary of a passable non—crop area. As the agricultural harvester (or work points on the agricultural harvester) cross the entry boundary of the passable non—crop area, a control system automatically generates control signals to adjust agricultural harvester control settings to control the harvester as the agricultural harvester passes through the non—crop area. Then, the system automatically detects when the work points of the agricultural harvester cross the exit boundary of the non—crop area part and again automatically adjusts operational settings of the agricultural harvester in response to the agricultural harvester exiting the non—crop area. This enhances the accuracy of the harvesting operation, reduces operator fatigue, and increases harvesting efficiency.

A description of a combine harvester is provided for the sake of example only. The present discussion could just as easily proceed with respect to other harvesters as well.

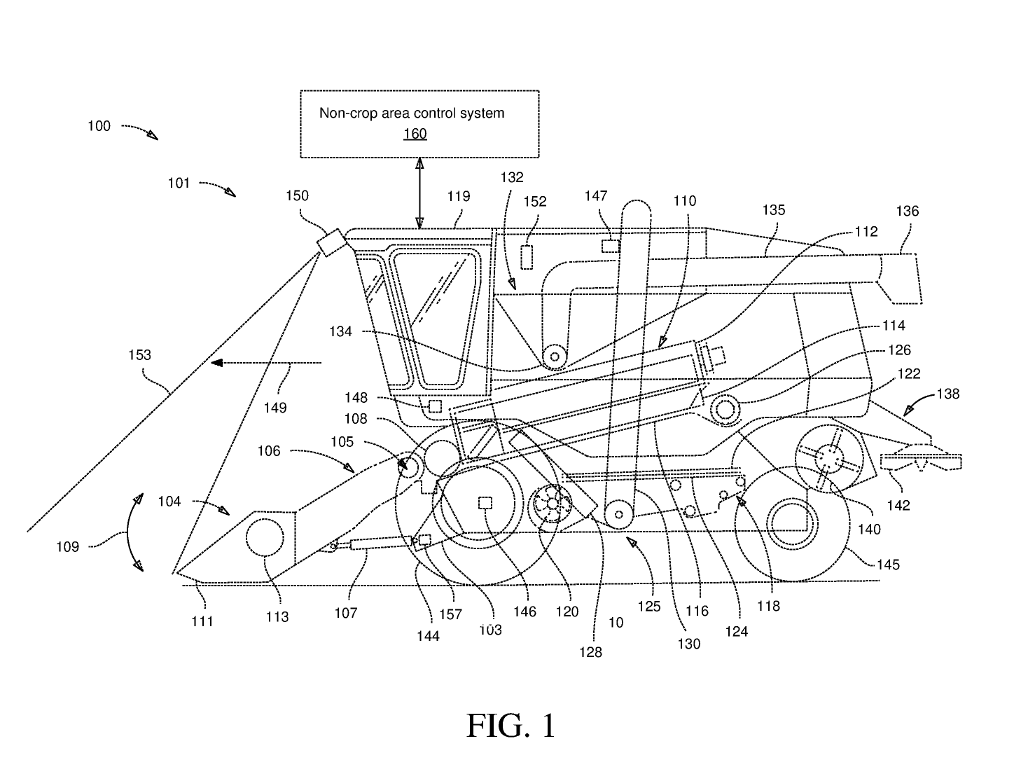

FIG. 1 is a partial schematic, partial pictorial illustration of an example agricultural system 100 with agricultural harvester 101. In the example shown in FIG. 1, agricultural harvester 101 is in the form of a combine harvester. As illustrated in FIG. 1, harvester 101 can include, or be coupled to, non-crop area control system 160. Harvester 101 includes ground engaging traction elements (wheels or tracks) 144 and 145 which can be driven by a propulsion subsystem (e.g., internal combustion engine, electric motors, hydrostatic drive, and other drivetrain elements, such as a gear box) to propel harvester 100 across a worksite (e.g., a field) 10. Harvester 101 includes an operator compartment or cab 119, which can include a variety of different operator interface mechanisms for controlling harvester 101 as well as for presenting (e.g., displaying, etc.) various information. Harvester 101 includes a feeder house 106, a feed accelerator 108, and a thresher generally indicated at 110. The feeder house 106 and the feed accelerator 108 form part of a material handling subsystem 125. Header 104 is pivotally coupled to a frame 103 of harvester 101 at pivot axis 105. One or more actuators 107 drive movement of header 104 about axis 105 in the direction generally indicated by arrow 109. Header 104 also has a cutter bar generally indicated by arrow 111. The cutter bar 111 severs crop material so that the crop material can be gathered by header 104 and fed through feeder house 106 for processing by other subsystems on harvester 101. Thus, a vertical position of header 104 and cutter bar 111 (the cutter bar height) above ground 10 over which the header 104 travels is controllable by actuating actuator 107 and may be sensed by cutter bar height sensor (or height sensor) 157. Height sensor 157 may sense the extent to which actuator 107 is actuated. Height sensor 157 may also be mounted on header 104 and include a radar sensor or another type of sensor that senses a distance indicative of the distance that cutter bar 111 is above the ground 10.

While not shown in FIG. 1, agricultural harvester 101 can also include one or more actuators that operate to apply a tilt angle, a roll angle, or both to the header 104 or portions of header 104.

Agricultural harvester 101 includes a material handling subsystem 125 that includes a thresher 110 which illustratively includes a threshing rotor 112 and a set of concaves 114. Further, material handling subsystem 125 also includes a separator 116. Agricultural harvester 101 also includes a cleaning subsystem or cleaning shoe (collectively referred to as cleaning subsystem 118) that includes cleaning fan(s) 120, chaffer 122, and sieve 124. The material handling subsystem 125 also includes discharge beater 126, tailings elevator 128, and clean grain elevator 130. The clean grain elevator 130 moves clean grain into a material receptacle (or clean grain tank) 132.

Harvester 101 also includes a material transfer subsystem that includes a conveying mechanism 134 and a chute 135. Chute 135 includes a spout 136. In some examples, spout 136 can be movably coupled to chute 135 such that spout 136 can be controllably rotated to change the orientation of spout 136. Conveying mechanism 134 can be a variety of different types of conveying mechanisms, such as an auger, blower, or belted conveyor. Conveying mechanism 134 is in communication with clean grain tank 132 and is driven (e.g., by an actuator, such as a motor or engine) to convey material from grain tank 132 through chute 135 and spout 136. Chute 135 is rotatable through a range of positions from a storage position (shown in FIG. 1) to a variety of deployed positions away from agricultural harvester 101 to align spout 136 relative to a material receptacle of a material receiving machine that is configured to receive the material from within grain tank 132. Spout 136, in some examples, is also rotatable, by an actuator, to adjust the direction of the material stream exiting spout 136.

Harvester 101 also includes a residue subsystem 138 that can include chopper 140 and spreader 142. In some examples, a harvester within the scope of the present disclosure can have more than one of any of the subsystems mentioned above. In some examples, harvester 101 can have left and right cleaning subsystems, separators, etc., which are not shown in FIG. 1.

In operation, harvester 101 illustratively moves through a field 10 in the direction indicated by arrow 149. As harvester 101 moves, header 104 engages the crop plants to be harvested and cutter bar 111 on the header 104 cuts the crop plants to generate severed crop material. The severed crop material is engaged by a cross conveyor (e.g. cross auger, belts, etc.) 113 which conveys the severed crop material to a center of the header 104 where the severed crop material is then moved through an opening to a conveyor in feeder house 106 toward feed accelerator 108, which accelerates the severed crop material into thresher 110. The severed crop material is threshed by rotor 112 rotating the crop against concaves 114. The threshed crop material is moved by a separator rotor in separator 116 where a portion of the residue is moved by discharge beater 126 toward the residue subsystem 138. The portion of residue transferred to the residue subsystem 138 is chopped by residue chopper 140 and spread on the field by spreader 142. In other configurations, the residue is released from the agricultural harvester 101 in a windrow.

Grain falls to cleaning subsystem 118. Chaffer 122 separates some larger pieces of materials other than grain (MOG) from the grain, and sieve 124 separates some of finer pieces of MOG from the grain. The grain then falls to a conveyor (e.g., an auger, etc.) that moves the grain to an inlet end of grain elevator 130, and the grain elevator 130 moves the grain upwards, depositing the grain in grain tank 132. Residue is removed from the cleaning subsystem 118 by airflow generated by one or more cleaning fans 120. Cleaning fans 120 direct air along an airflow path upwardly through the sieves and chaffers. The airflow carries residue rearwardly in harvester 101 toward the residue handling subsystem 138.

Tailings elevator 128 returns tailings to thresher 110 where the tailings are re-threshed. Alternatively, the tailings also can be passed to a separate re-threshing mechanism by a tailings elevator or another transport device where the tailings are re-threshed as well.

Harvester 101 can include a variety of sensors, some of which are illustrated in FIG. 1, such as ground speed sensor 146, one or more mass flow sensors 147, position sensor 148, one or more observation sensor systems (or perception sensor) 150, one or more fill level sensors 152, height sensor 157, and any of a variety of other sensors.

Ground speed sensor 146 senses the travel speed of harvester 101 over the ground. Ground speed sensor 146 can sense the travel speed of the harvester 101 by sensing the speed of rotation of the ground engaging traction elements 144 or 145, or both, a drive shaft, an axle, or other components. In some instances, the travel speed can be sensed using a position sensor (or positioning system) 148, such as a global positioning system (GPS), a dead reckoning system, a long-range navigation (LORAN) system, a Doppler speed sensor, or a wide variety of other systems or sensors that provide an indication of travel speed. Ground speed sensors 146 can also include direction sensors such as a compass, a magnetometer, a gravimetric sensor, a gyroscope, GPS derivation, to determine the direction of travel in two or three dimensions in combination with the speed. This way, when harvester 101 is on a slope, the orientation of harvester 101 relative to the slope is known. For example, an orientation of harvester 101 could include ascending, descending or transversely travelling the slope.

Mass flow sensors 147 sense the mass flow of material (e.g., grain) through clean grain elevator 130. Mass flow sensors 147 can be disposed at various locations, such as within or at the outlet of clean grain elevator 130. In some examples, the mass flow rate of material sensed by mass flow sensors 147 is used in the calculation of yield as well as in the calculation of the fill level of the on-board material tank 132. In some examples, mass flow sensors 147 include an impact (or strike) plate that is impacted by material (e.g., grain) conveyed by clean grain elevator 130 and a force or load sensor that detects the force or load of impact of the material on the impact (or strike) plate. This is merely one example of a mass flow sensor.

Observation sensor systems (or perception systems) 150 can include one or more of a variety of sensors, such as cameras (e.g., mono cameras, stereo cameras, color (e.g. RGB) cameras, multispectral cameras, etc.), lidar sensors, radar sensors, ultrasonic sensors, as well as various other sensors configured to emit and/or receive electromagnetic radiation, as well as a variety of other sensors. Systems 150 can also include image or sensor processing functionality or other processing functionality that can be used to identify items captured in images or otherwise perceived and that locate the identified items in a global or local coordinate system. Observation sensor systems 150 can illustratively observe (and thus detect characteristics relative to) the worksite 10, items at the worksite 10 (e.g., vegetation, terrain, including crops and non-crop areas at the worksite), and portions of the harvester 101. While FIG. 1 shows one example position of observation sensor system 150, it will be understood that observation sensor systems 150 can, alternatively or additionally, be positioned (or otherwise disposed) at a variety of other locations on harvester 101. In the example shown in FIG. 1, observation sensor system 150 has a field of view identified by dashed lines 153. The field of view captures the work surface (i.e., ground) 10 ahead of harvester 101, and there may be another observation sensor system 150 positioned to have a field of view to capture the work surface behind harvester 101.

Fill level sensors 152 can include one or more of a variety of sensors, such as contact sensors and non-contact sensors. Fill level sensors 152 detect a fill level of grain in grain tank 132. Fill level sensors 152, in the form of contact sensors, include paddles (or other contact members) that are contacted by the grain and the displacement of the contact members or force or load of impact of the material on the contact member can be detected to determine presence of grain material at the level of the tank corresponding to the sensor. Fill level sensors 152, in the form of non-contact sensors, can be configured to capture electromagnetic radiation to detect presence of grain at the level of the tank corresponding to the sensor. In some examples, fill level sensors 152 are configured to alert an operator when the harvester 101 is full (or is approaching full). These are merely some examples. While FIG. 1 shows some example positions of fill level sensors 152, it will be understood that fill level sensors 152 can, additionally or alternatively, be positioned (or otherwise disposed) at a variety of other locations on harvester 101 and can include cameras or other sensors.

As discussed above, cutter bar height sensor 157 can be a sensor that senses the extent to which actuator 107 is actuated, such as a linear position sensor or a Hall Effect sensor. Sensor 157 can be a rotary sensor mounted to sense a rotary position of header 104 about axis 105. Sensor 157 can be a radar sensor, a laser sensor, a global navigation satellite system (GNSS) sensor, or another sensor that senses a variable indicative of an elevation of cutter bar 111 or the distance that cutter bar 111 is located above the ground 10.

Also, as discussed above, it may be that agricultural harvester 101 is harvesting in a field that has passable non—crop areas. In that case, it may also be that it is desirable to change the operational settings of agricultural harvester 101 while agricultural harvester traverses the non—crop area, and then either revert to prior operational settings or change to different operational settings when the agricultural harvester 101 emerges on the other side of the passable non—crop area.

By way of example, assume that during a harvesting operation in a field 10, agricultural harvester 101 approaches a waterway in the field 10. Assume further that it is desirable to have the agricultural harvester 101 proceed at a higher rate of speed across the waterway and then slow down as the agricultural harvester 101 again commences harvesting on the opposite side of the waterway.

Therefore, in one example, non—crop area control system 160 receives an input that indicates when agricultural harvester 101 is approaching an entry boundary of a passable non—crop area in a field. Then, non—crop area control system 160 determines when the working points of agricultural harvester 101 cross the entry boundary to the non-crop area (e.g., when header 104 crosses the boundary, when the front wheels 144 cross the boundary, when the rear wheels 145 cross the boundary, etc.). In response to the working point or working points of agricultural harvester 101 crossing the entry boundary of the passable non—crop area, non—crop area control system 160 modifies the disc control settings that control the operations of agricultural harvester 101. For instance, non—crop area control system 160 can increase the ground speed of agricultural harvester 101, decrease the ground speed of agricultural harvester 101, change the header height of header 104, or generate other control signals that control the operation of agricultural harvester 101 as it crosses the passable non—crop area. Non—crop area control system 160 then receives a signal indicating that agricultural harvester 101 is approaching or crossing an exit boundary of the passable non—crop area. In response to the working points of agricultural harvester 101 crossing the exit boundary, non—crop area control system 160 can again change the operational settings of agricultural harvester 101 accordingly. For instance, if agricultural harvester 101 is to commence the harvesting operation after header 104 crosses the exit boundary of the passable non—crop area, then non—crop area control system 160 can generate control signals to again change the ground speed of agricultural harvester 101, to reset the header height of header 104, etc.

There are a variety of different ways in which non—crop area control system 160 can detect whether agricultural harvester 101 is entering or exiting a non—crop area. In one example, perception system 150 is a camera or other sensor that captures an image or other representation of the area in front of header 104. Non-crop area control system 160 can process that image or representation to identify an entry boundary into a passable non—crop area, and an exit boundary out of a passable non– crop area, etc. Based upon the location of perception system 150 relative to the working points of agricultural harvester 101 and based on the ground speed of agricultural harvester 101, non—crop area control system 160 can determine where and/or when the working points of harvester 101 will cross the entry boundary or exit boundary. In another example, non—crop area control system 160 can receive a map that has a geo-referenced indication identifying passable non—crop areas in the field 10. Non—crop area control system 160 can then access the location, heading, and ground speed of agricultural harvester 101 output by position sensor 148 and ground speed sensor 146 to determine when the working points of agricultural harvester 101 are entering and/or exiting a passable non—crop area using the map. Non—crop area control system 160 can identify whether agricultural harvester 101 is entering or exiting a non—crop area in other ways as well.

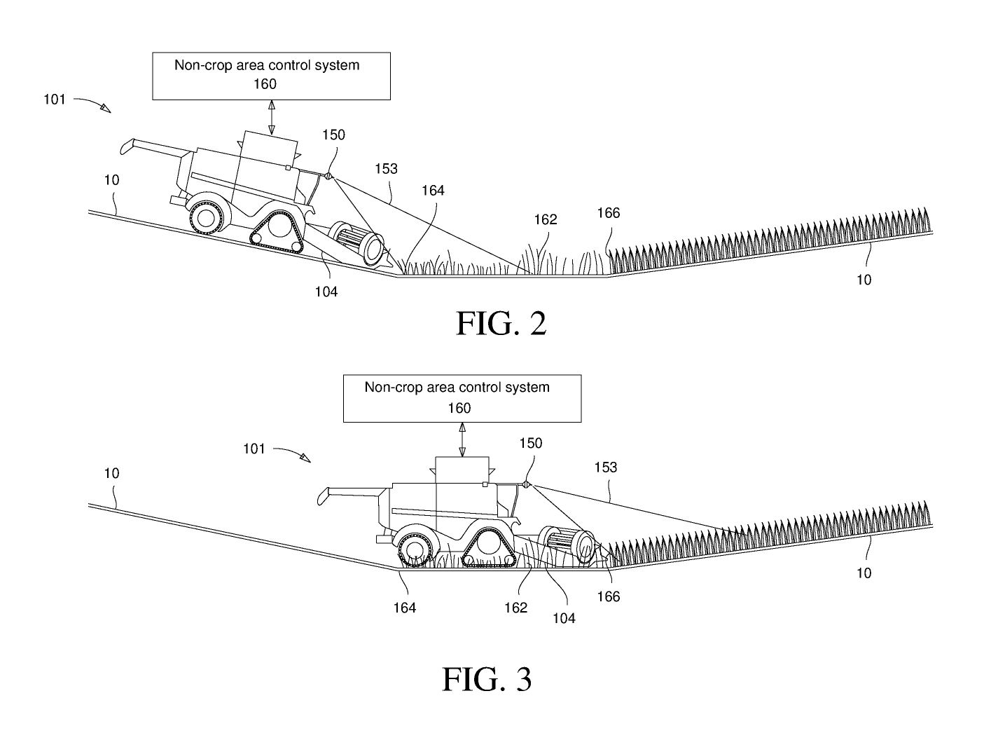

FIGS. 2, 3, and 4 show a pictorial illustration of agricultural harvester 101 approaching, traversing, and exiting, a passable non—crop area 162, respectively. In FIG. 2, the non—passable crop area 162 is illustrated as a waterway.

FIG. 2 shows that perception sensor 150 has a field of view 153 that includes the field 10 forward of header 104. In one example, sensor 150 captures an image of field 10 along the field of view 153. That image is provided to non—crop area control system 160. In one example, system 160 includes an image processing system (such as a convolutional neural network, or another image processing system) that is trained or otherwise configured to identify a non—crop area 162. In one example, the image processing system is trained to identify an entry boundary 164 of the non—crop area 162 as well as an exit boundary 166 of the non—crop area 162. Thus, as agricultural harvester 101 approaches the non—crop area 162, the image captured by sensor 150 will include the entry boundary 164. The entry boundary 164 can be identified in that image and the location of the entry boundary 164 can be identified relative to the working points of agricultural harvester 101. For instance, non—crop area control system 160 may include a processing system that accesses the dimensions of agricultural harvester 101 and the orientation of sensor 150 on agricultural harvester 101. Based upon that information, and based upon the identity of the working points of agricultural harvester 101, non—crop area control system 160 can determine when and/or where the working points of agricultural harvester 101 will cross the entry boundary 164.

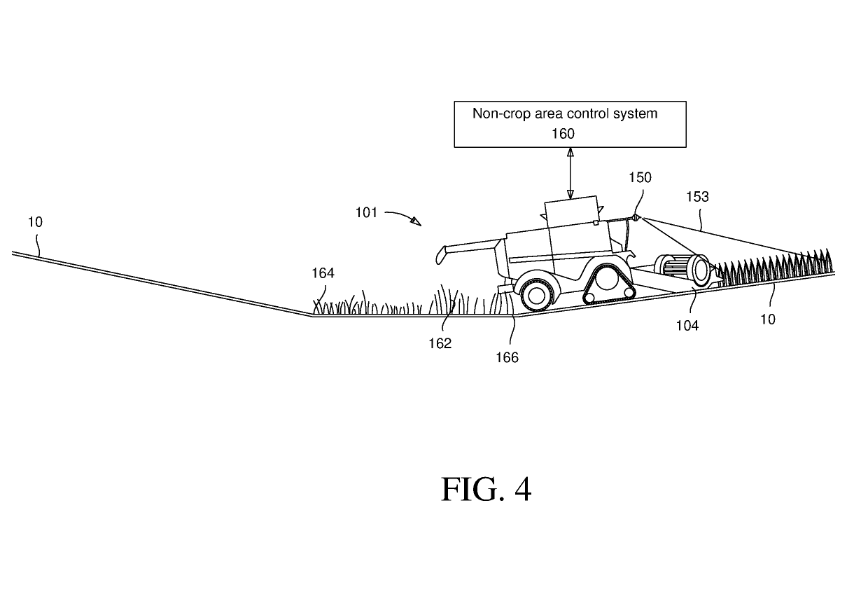

FIG. 3 illustrates agricultural harvester 101 traversing the non—crop area 162 between the entry boundary 164 and the exit boundary 166. In response to the working points of agricultural harvester 101 crossing the entry boundary 164, non—crop area control system 160 can generate a control signal to modify the control settings controlling the operation of certain systems or subsystems on agricultural harvester 101 while agricultural harvester 101 is traversing the non—crop area with 162. Thus, for example, non—crop area control system 160 can increase the ground speed of agricultural harvester 101, raise the header height of header 104, or perform other control operations while agricultural harvester 101 is traversing the non—crop area 162. FIG. 3 also shows that sensor 150 now has a field of view 153 that includes the exit boundary 166 of the non—crop area 162. Therefore, the sensor processing system in non—crop area control system 160 can process an image of the field of view to identify the exit boundary 166. Based upon when and/or where the working points of agricultural harvester 101 will cross the exit boundary 166, non—crop area control system 160 can again generate control signals to change the control settings of agricultural harvester 101 so that agricultural harvester 101 is controlled in a desired way after it exits the passable non—crop area 162 (e.g., after the work points on agricultural harvester 101 cross the exit boundary 166 of non—crop area 162). In FIG. 3, it can be seen that the field of view 153 of sensor 150 will have captured exit boundary 166. Therefore, as the work point(s) of agricultural harvester 101 approach exit boundary 166, agricultural harvester 101 can be controlled to resume the speed, header height, etc. that will be used when agricultural harvester 101 crosses exit boundary 166.

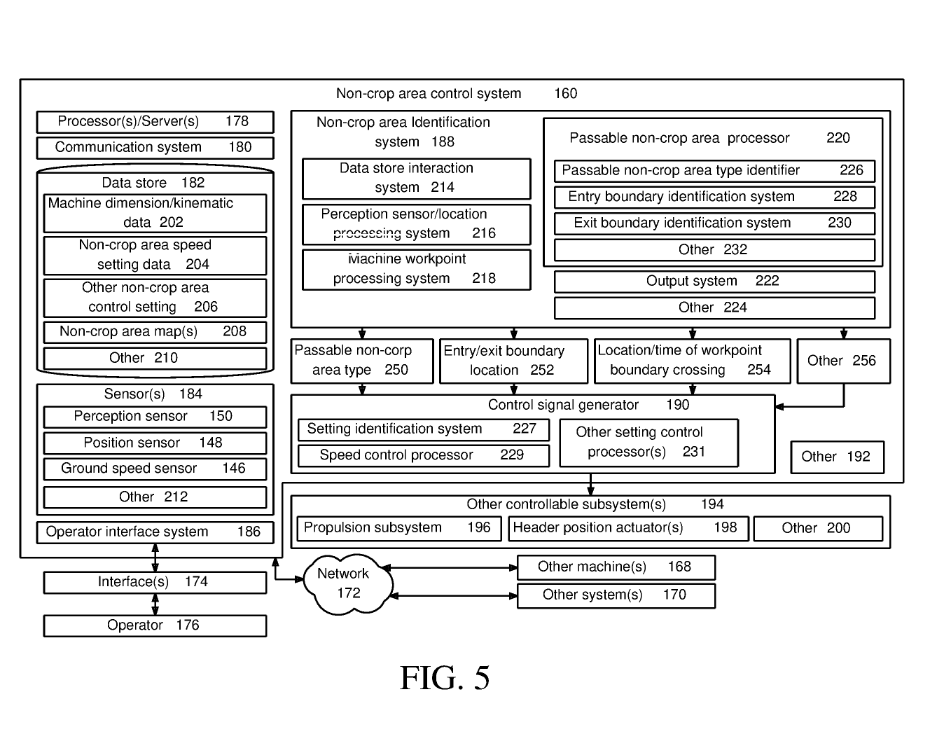

FIG. 4 shows that agricultural harvester 101 has now crossed the exit boundary 166 of non—crop area 162. Therefore, non—crop area control system 160 will have reduced the ground speed of agricultural harvester 101 to a ground speed that is suitable for harvesting, and lowered the header height of header 104 to a desired header height.

It will be noted that the control signals generated by non—crop area control system 160 on the first side of non—crop area 162 (e.g., on the side where agricultural harvester 101 is harvesting and FIG. 2) may be the same or different from the control signals generated by non—crop area control system 160 on the opposite side of non—crop area 162 (e.g., on the side where agricultural harvester 101 is harvesting in FIG. 4). It will also be noted that, while one example controls agricultural harvester to raise header 104 and increase ground speed as agricultural harvester crosses non-crop area 162, other examples of controlling agricultural harvester 101 can be used as well. For instance, if the non-crop area 162 is rough, then the speed of agricultural harvester 101 can be reduced as agricultural harvester 101 traverses non-crop area 162. Similarly, the speed of agricultural harvester 101 can be maintained the same when traversing non-crop area 162 as during harvesting. Other examples of control can be used as well.

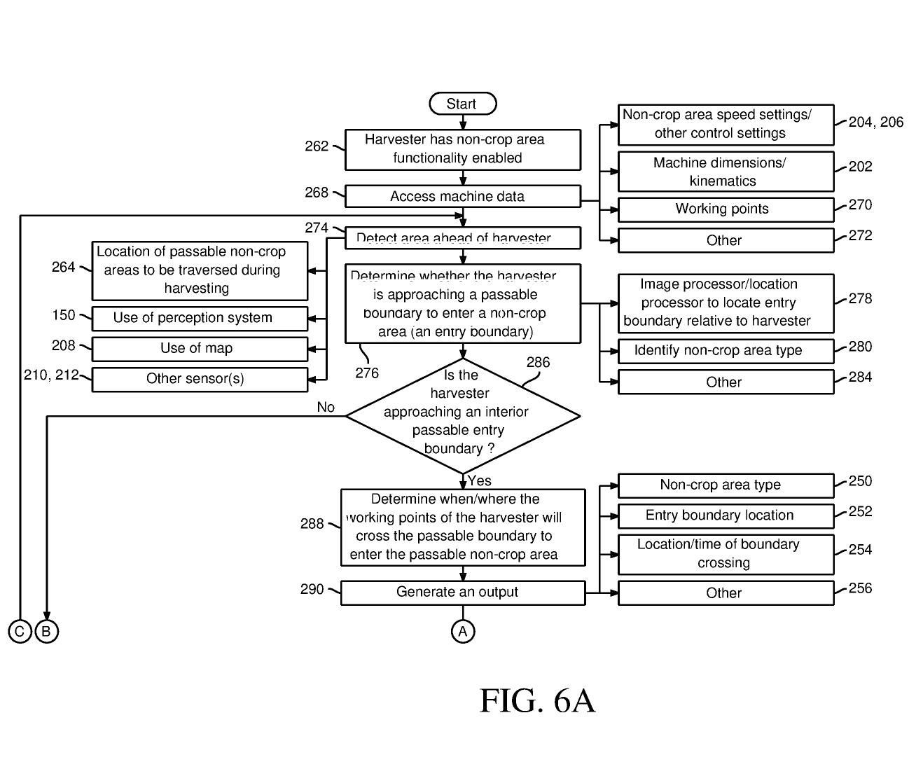

FIG. 5 is a block diagram showing one example of non—crop area control system 160 in more detail. In the example shown in FIG. 5, non—crop area control system 160 is shown connected to other machines 168 and other systems 170 over a network 172. Other machines 168 may be other harvesters operating in field 10, tender vehicles, or other machines. Other systems 170 may be farm manager systems, vendor systems, maintenance systems, or other systems. Other systems 170 may be located in a remote server environment, on a farm manager computing system, or elsewhere. Network 172 may be a wide area network, a local area network, a near field network, a Wi-Fi or Bluetooth network, a cellular network, or any of a wide variety of other networks or combinations of networks.

FIG. 5 also shows that non—crop area control system 160 can generate interfaces 174 for interaction by an operator 176. Operator 176 may be a human operator located in the operator compartment 119 of agricultural harvester 101, or an automated operator, or a semi- automated operator. Therefore, operator 176 can interact with interfaces 174 to control and manipulate non—crop area control system 160 and some parts of agricultural harvester 101.

In the example shown in FIG. 5, non—crop area control system 160 includes one or more processors or servers 178, communication system 180, data store 182, one or more sensors 184, operator interface system 186, non—crop area identification system 188, control signal generator 190, and other system functionality 192. Control signal generator 190 is shown generating control signals to control various controllable subsystems 194 which can include a propulsion subsystem 196, a header position actuator 198, and/or any of a wide variety of other controllable subsystems 200. Propulsion subsystem 196 can be an internal combustion engine, and electric motor, a transmission, and/or any of a wide variety of other propulsion systems and transmissions that can be used to propel agricultural harvester 101.

Data store 182 can include machine dimension and kinematic data 202, non—crop area speed setting data 204, other non—crop area control settings 206, non—crop area maps 208, and any of a wide variety of other information 210.

Sensors 184 can include one or more perception sensors 150, position sensor 148, ground speed sensor 146, and any of a wide variety of other sensors 212. Non-crop area identification system 188 can include data interaction system 214, perception sensor/location processing system 216, machine work point processing system 218, passable non—crop area processor 220, output system 222, and other items 224. Passable non—crop area processor 220 can include passable non—crop area identifier 226, entry boundary identification system 228, exit boundary identification system 230, and other items 232. Control signal generator 190 can include setting identification system 227, speed control processor 229, and one or more other settings control processors 231. Before describing the overall operation of non—crop area control system 160 in more detail, a description of some of the items in non—crop area control system 160, and their operation, will first be provided.

Communication system 180 facilitates communication of the items in non—crop area control system 160 with one another, and also facilitates communication over network 172. Therefore, communication system 180 can be a controller area network (CAN) bus and bus controller, a cellular communication system, a wide area network communication system, a local area network communication system, a Bluetooth or Wi-Fi communication system, a near field communication system, and/or any of a wide variety of other communication systems or combinations of systems.

Machine dimension/kinematic data 202 defines various dimensions of agricultural harvester 101. The dimensions may identify where particular points (e.g., work points such as the front wheels 144, rear wheels 145, header 104, etc.) are on agricultural harvester 101 relative to position sensor 148, relative to one another, or relative to another reference point. The kinematic data 202 may define how various portions of agricultural harvester 101 move in three-dimensional space. Non—crop area speed setting data 204 may identify speed settings for controlling agricultural harvester 101 when agricultural harvester 101 is traversing a non—crop area. There may be a default speed setting or another speed setting that can be used when agricultural harvester 101 is crossing a non—crop area. Also, there may be different speed settings depending on the type of non—crop area. For instance, if agricultural harvester 101 is crossing a waterway, then the non—crop area speed setting data 204 may identify a first speed. However, if agricultural harvester 101 is crossing an infield road, then non—crop area speed setting data 204 may identify a different speed setting. These are examples only.

Other non—crop area control settings 206 may define other settings that are to be controlled based on, or in response to, agricultural harvester 101 traversing a non—crop area. Such control settings 206 may include header height settings and/or a wide variety of other control settings.

Non—crop area maps 208 may include data that geographically references non—crop areas in a field 10. For instance, the non—crop area maps 208 may provide geo-referenced waterways, geo-referenced field roads, or other geo-referenced non—crop areas in field 10. The map may indicate whether the non—crop areas are passable areas or impassable areas. For instance, where a waterway is adjacent a non—passable boundary of field 10, then that waterway (even though it may be passable) may be identified as non—passable because the agricultural harvester 101 is not free to exit the waterway on the opposite side (on the field boundary side) of the non-crop area.

Perception sensors 150 are described above. Position sensor 148 may be a global navigation satellite system (GNSS) receiver, a dead reckoning system, a cellular triangulation system, or any of a wide variety of other systems that senses the position of sensor 148 in a global or local coordinate system. Some examples of ground speed sensor 146 are described above as well. Sensors 184 can include a wide variety of other sensors 212 as well.

Operator interface system 186 can include operator interface mechanisms that operator 176 can interact with. For instance, the operator interface mechanisms may include a steering wheel, joysticks, pedals, linkages, buttons, levers, etc. The operator interface mechanisms may also include a display, lights, a speaker, or other items that provide audio, visual, and/or haptic information to operator 176. The operator interface mechanisms may include a display screen that displays user input mechanisms, such as icons, links, buttons, or other mechanisms that may be actuated by a point-and-click device, by touch gestures, by voice commands, or in other ways. The operator interface mechanisms may include a microphone (such as where speech recognition and/or speech synthesis are provided) and other mechanisms as well.

Data store interaction system 214 can interact with data store 182 or other data stores to obtain information. For instance, data store interaction system 214 may access the machine dimension/kinematic data 202, the non—crop area speed setting data 204, the other non—crop area control settings data 206, the non—crop area maps 208, and other data 210.

Perception sensor/location processing system 216 can receive an input from perception sensor 150. The sensor signal from perception sensor 150 may be indicative of an image captured by perception sensor 150. That image may include the area of field 10 ahead of agricultural harvester 101 in the direction of travel. Thus, perception sensor/location processing system 216 may include a convolutional neural network, or any of wide variety of other image processing functionality that can be used to determine whether the image includes a boundary to a passable non—crop area 162. Perception sensor/ location processing system 216 can process the image and generate an output indicative of the items contained in the image, recognized from the image, or indicative of features extracted from the image.

In another example, image sensor/location processing system 216 can access a map 208 that has non-crop areas in field 10 geo-referenced. Based on the location and heading of agricultural harvester 101 (such as obtained from position sensor 148 or in other ways), processing system 216 can generate an output indicating that agricultural harvester 101 is approaching a passable non-crop area.

Passable non—crop area processor 220 can generate an output indicative of various information about a detected non-crop area. For instance, passable non—crop area processor 220 identifies the type of non—crop area that is identified (either from a map 208 or from the processed image), and also identifies the location of entry boundaries and exit boundaries if those boundaries are found in the map 208 or processed image.

More specifically, in one example, passable non-crop area type identifier 226 processes the image or accesses the map (or both) to identify the type of passable non—crop area (such as whether the passable non-crop area is an infield road, a waterway, etc.). Thus, identifier 226 may be a classifier, a rules-based identifier, or another component that receives an image or features extracted from an image and/or a map 208, and/or other information and generates an output indicative of the type of passable non-crop area. Entry boundary identification system 228 locates an entry boundary of a passable non—crop area in the image or on the map and exit boundary identification system 230 can similarly locate an exit boundary of a passable non—crop area. When using a captured image, systems 228 and 230 can use machine dimension data or other data that identifies the location and orientation of perception sensor 150 relative to a reference point on agricultural harvester 101. The locations of the boundaries can be output in terms of locations or offsets relative to a reference point on agricultural harvester 101, or the locations can be output as absolute coordinates in a local or global coordinate system or identified in other ways.

Machine work point processing system 218 can then identify the ground speed of agricultural harvester 101 and determine when and/or where any of the work points of agricultural harvester 101 will cross the boundaries that were identified. For instance, if the identified boundary is an entry boundary, then machine work point processing system 218 may access the machine dimension/kinematic data 202 and the ground speed of agricultural harvester 101 output by ground speed sensor 146 to identify when or where the forward most work point on agricultural harvester 101 (e.g., the header 104 or front wheels 144) will cross the entry boundary. If the boundary is an exit boundary, then machine work point processing system 218 may determine where or when the rearward most work point on agricultural harvester 101 will cross the exit boundary. These are examples only.

Output system 222 can output the various information generated by non—crop area identification system 188. For instance, output system 222 can output a passable non—crop area type indicator 250 that identifies the type of passable non-crop area that agricultural harvester 101 is approaching. Output system 222 can generate an output indicative of the location of entry and exit boundaries as indicated by block 252. Output system 222 can generate an output indicative of the location and or time when any of the work points on agricultural harvester 101 will cross the boundaries, as indicated by block 254. Output system 222 can output any of wide variety of other items 256 as well.

The outputs 250 – 256 can be provided to control signal generator 190 as well as to operator interface system 186, communication system 180, data store 182, or other items 192. Based upon the outputs 250-256, control signal generator 190 generates control signals to control communication system 180, operator interface system 186, and/or any of wide variety of other controllable subsystems 194. For instance, when the outputs 250 – 256 indicate that a work point on agricultural harvester 101 is about to cross an entry boundary into a passable non—crop area, then setting identification system 227 can access the non—crop area speed setting data 204 and/or the other non-crop area control settings data 206 to identify settings values that should be used when agricultural harvester 101 is traversing a non—crop area of the type indicated by the passable non-crop area type indicator 250. Speed control processor 229 can then generate a control signal to control a propulsion system 196 to control the ground speed of agricultural harvester 101 according to the speed settings data. Other control processor(s) 231 can generate other control signals to control other systems, such as a header position actuator 198 that positions the height of header 104. The control signals can be generated to control communication system 180 to communicate the locations of the entry and exit boundaries, the types of passable non—crop areas that are being encountered, and other information to other machines 168 and other systems 170. For instance, other systems 170 may include a mapping system that generates a map of passable non—crop areas for a field. Thus, the mapping system can use the information received from control signal generator 190 to generate such a map. Control signal generator 190 can also generate control signals to control operator interface system 186 to display the information on interfaces 174 for operator 176. Other control signals can be generated as well.

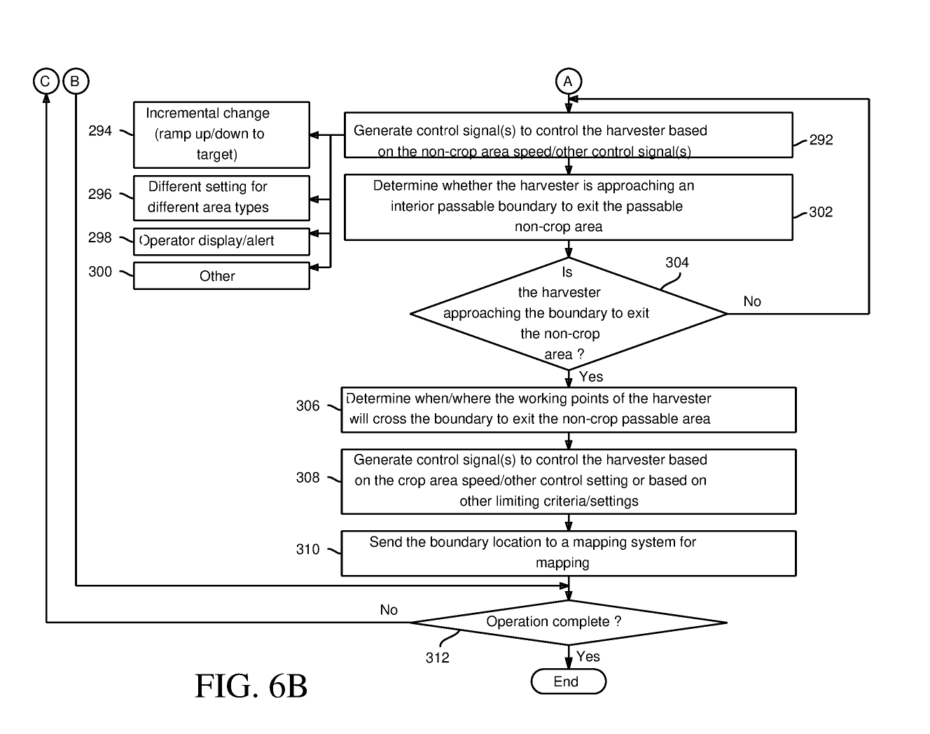

FIGS. 6A and 6B (collectively referred to herein as FIG. 6) show a flow diagram illustrating one example of the operation of non—crop area control system 160 in more detail. It is first assumed that agricultural harvester 101 has non—crop control functionality (such as non—crop area control system 160) enabled as indicated by block 262 in the flow diagram of FIG. 6. It will be appreciated that the functionality of non—crop area control system 160 can be located on harvester 101, on other systems 170, dispersed among a plurality of different locations, or located elsewhere.

Data store interaction system 214 then accesses machine data from data store 182, or from another data store, as indicated by block 268 in the flow diagram of FIG. 6. Data store interaction system 214 can access non—crop area speed settings data 204, other control settings 206, machine dimensions and kinematic data 202, the dimension data indicative of the location of working points on agricultural harvester 101, as indicated by block 270, and/or any of a variety of other settings data or other data, as indicated by block 272.

Non—crop area identification system 188 detects the area ahead of harvester 101 in the direction of travel as indicated by block 274 in the flow diagram of FIG. 6. In one example, non-crop area identification system 188 detects the area ahead of harvester 101 to identify whether that area contains a passable non-crop area to be traversed while harvesting as indicated by block 264. The area ahead of harvester 101 can be detected using a perception system or perception sensor 150, using the location and heading of harvester 101 (output by position sensor 148) along with one or more maps 208, or any of wide variety of other sensors or systems for detecting the area ahead of harvester 101 in the direction of travel as indicated by block 210, 212 in the flow diagram of FIG. 6.

Passable non-crop area processor 220 then determines whether the harvester 101 is approaching a passable entry boundary to enter a non-crop area 162. Making such a determination is indicated by block 276 in the flow diagram of FIG. 6. In one example, perception sensor/location processing system 216 processes an image taken by perception sensor 150 to identify items in that image and entry boundary identification system 228 determines whether agricultural harvester 101 is approaching an entry boundary based upon the processed image. Processing an image with an image processor is indicated by block 278 in the flow diagram of FIG. 6. In another example, data store interaction system 214 accesses a non-crop area map 208 which has geo-referenced non-crop areas located on the map. The map 208 can be processed by perception sensor/location processing system 216 in conjunction with the position of agricultural harvester 101 output by position sensor 148 to determine whether agricultural harvester 101 is approaching a passable boundary to enter a non-crop area 162 (e.g., whether the agricultural harvester 101 is approaching an entry boundary). Processing a map 208 is indicated by block 280 in the flow diagram of FIG. 6. Thus, entry boundary identification system 228 can perform further image processing on an image or features extracted from an image by perception sensor/location processing system 216 or entry boundary identification system 228 can incorporate other logic that locates an entry boundary relative to harvester 101 based on data from a map 208, as indicated by block 278.

In addition, passable non-crop area type identifier 226 identifies the type of non-crop area (such as whether it is a waterway, an in-field road, etc.) as indicated by block 280 in the flow diagram of FIG. 6. Passable non-crop area processor 220 can identify any of wide variety of other characteristics 284 of the non-crop area being sensed as well.

If agricultural harvester 101 is in fact approaching an interior passable entry boundary, as determined at block 286, then machine work point processing system 218 determines when and where the working points of the agricultural harvester 101 will cross the passable boundary to enter the non-crop area, as indicated by block 288. For instance, system 218 can obtain the location of agricultural harvester 101 from position sensor 148, as well as the heading of agricultural harvester 101. System 218 can obtain the ground speed of agricultural harvester 101 from ground speed sensor 146. Based upon the location of the entry boundary, as output by passable non-crop area processor 220, and based upon the location, heading and speed of agricultural harvester 101, machine work point processing system 218 can generate an output indicating when or where the work points of agricultural harvester 101 will cross the entry boundary.

Output system 222 then generates an output to control signal generator 190 indicating the passable non-crop area type 250, the boundary location of the entry boundary 252, the location and/or time when the work points on agricultural harvester 101 will cross the entry boundary 254, and other items 256. Generating such an output and providing the output to control signal generator 190 is indicated by block 290 in the flow diagram of FIG. 6.

Based on the outputs from output system 222, control signal generator 190 can generate control signals to control the agricultural harvester 101. For instance, the control signals can control agricultural harvester 101 based upon the type of non-crop area that is being, or is about to be, traversed by agricultural harvester 101, the non-crop area speed settings data 204, the other non-crop area control settings data 206, and other data. Generating such control signals is indicated by block 292 in the flow diagram of FIG. 6. In one example, settings identification system 226 identifies the values of the new settings to be used in the passable non-crop area. Speed control processor 228 generates a speed control signal based upon the new settings and other settings control processor 230 generates other control signals based upon other settings.

The control signals generated by control signal generator 190 can be used to gradually change the settings to a target value (such as to ramp up or down to a target speed), or to incrementally change the settings in other ways. Incrementally changing the settings (e.g., to ramp to a target setting) is indicated by block 294 in the flow diagram of FIG. 6.

As discussed above, there may be different settings for different types of non-crop areas identified by the passable non-crop area type indicator 250. Having different settings for different non-crop area types as indicated by block 296 in the flow diagram of FIG. 6. The control signals can be used to control operator interface system 186, as indicated by block 298. Other control signals can be used to control other functionality, as indicated by block 300.

Once it is determined that agricultural harvester 1901 is traversing a non-crop area, then non-crop area identification system 188 determines whether the agricultural harvester 101 is approaching an interior passable boundary to exit the non-crop passable area (e.g., whether agricultural harvester 101 is approaching an exit boundary). Determining whether agricultural harvester 101 is approaching an exit boundary is indicated by block 302 in the flow diagram of FIG. 6. This can be done in the same way as discussed above with respect to block 276 or in a different way.

If the agricultural harvester 101 is not approaching the exit boundary of the non-crop area, then processing reverts to block 292 where control signal generator 190 continues to generate control signals to control agricultural harvester 101 as it traverses the non-crop area. However, if, at block 304, it is determined that the agricultural harvester 101 is approaching the exit boundary of a non-crop area, then machine work point processing system 218 determines when and where the work points of the agricultural harvester 101 will cross the exit boundary of the non-crop area, as indicated by block 306 in the flow diagram of FIG. 6. Output system 222 can then generate an exit boundary location 252 and a location and time indicator indicating when the work points of agricultural harvester 101 will cross the exit boundary (as shown at 254 in FIG. 5). Control signal generator 190 then generates control signals to control the agricultural harvester 101 based upon the desired settings for the crop area that agricultural harvester will enter after crossing out of the non-crop area as indicated by block 308. Those settings can be the same settings as were used prior to harvester 101 entering the non-crop area. However, if conditions on the opposite side (the exit side) of the non-crop area are different from those on the entry side, so that the settings should have different values, then control signal generator 190 generates control signals based upon the new conditions.

Also, at some point during the processing, control signal generator 190 generates control signals to control communication system 180 to send the locations of the entry and exit boundaries of the passable non-crop area to a mapping system for map generation, as indicated by block 310 in the flow diagram of FIG. 6. The mapping system may be located on one of the other systems 170 or located elsewhere.

Until the operation is complete, as determined at block 312 in FIG. 6, processing reverts to block 274 where non-crop area control system 160 continues to detect an area ahead of agricultural harvester 101 in the direction of travel (either using a sensor, or using a map, or using another mechanism).

It can thus be seen that the present description describes a system which automatically detects or otherwise identifies when agricultural harvester 101 is approaching a passable non-crop area. Non-crop area control system 160 applies control signals that are to be employed while agricultural harvester 101 is traversing the passable non-crop area. Once the agricultural harvester 101 crosses through the passable non-crop area, then non-crop area control system 160 generates control signals to control agricultural harvester 110 accordingly. This increases the efficiency with which agricultural harvester 101 can perform a harvesting operation. It also decreases operator fatigue and errors introduced by human operators.

The present description describes one or more processors and servers. The processors and servers can include computer processors with associated memory and timing circuitry (not separately shown). The processors and servers may be parts of the systems or devices to which they belong and may be activated by, and facilitate the functionality of, the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, sensors, and/or logic. It will be appreciated that such systems, components, generators, sensors, and/or logic can be comprised of hardware items (such as processors and associated memory, or other processing components, some of which are described below) that perform the functions associated with those systems, components, generators, sensors, and/or logic. In addition, the systems, components, generators, and/or logic can be comprised of software that is loaded into a memory and is subsequently executed by a processor or server, or other computing component, as described below. The systems, components, generators, sensors, and/or logic can also be comprised of different combinations of hardware, software, firmware, etc., some examples of which are described below. These are only some examples of different structures that can be used to form the systems, components, generators, sensors, and/or logic described above. Other structures can be used as well.

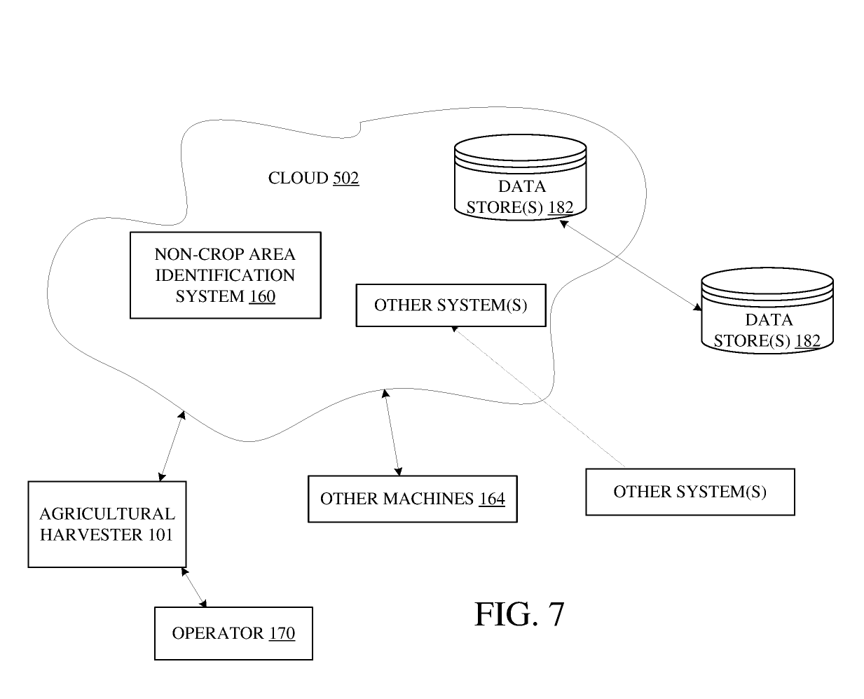

FIG. 7 is a block diagram of an agricultural system 100, shown in FIG. 1, except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 7, some items are similar to those shown in previous FIGS. and they are similarly numbered. FIG. 7 specifically shows that non-crop area control system 160, or parts of system 160, such as data store 182, can be located at a remote server location 502. Therefore, harvester 101 accesses those systems through remote server location 502.

FIG. 7 also depicts another example of a remote server architecture. FIG. 7 shows that it is also contemplated that some elements of previous FIGS are disposed at remote server location 502 while others are not. By way of example, remote storage 182 or other systems 170 can be disposed at a location separate from location 502 and accessed through the remote server at location 502. Regardless of where the items are located, they can be accessed directly by harvester 101, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

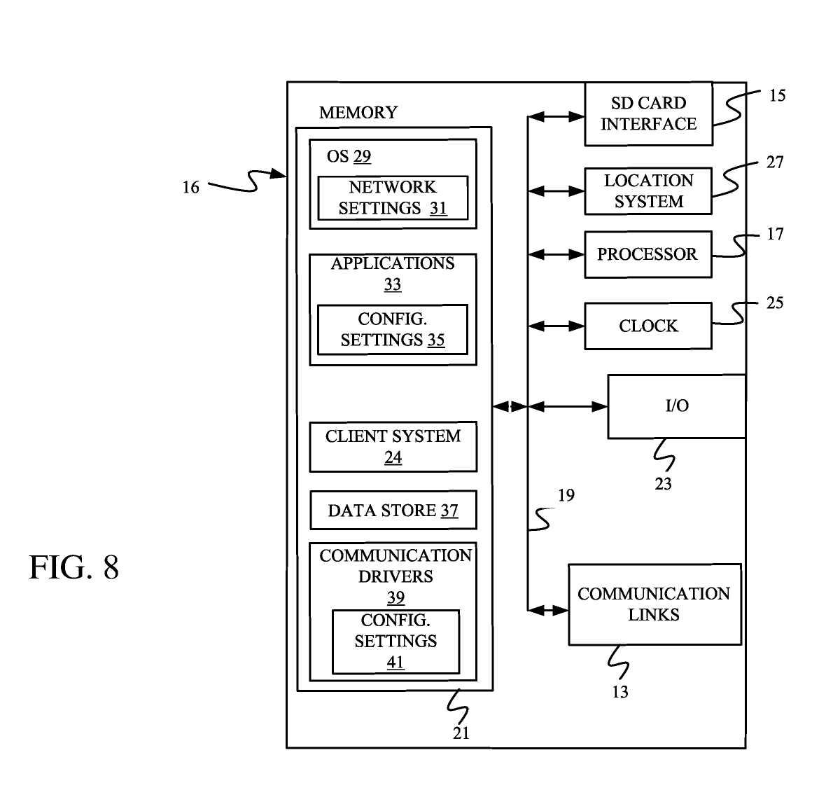

FIG. 8 is a simplified block diagram of one illustrative example of a handheld or mobile computing device that can be used as a user’s or client’s handheld device 16, in which the present system (or parts of it) can be deployed. For instance, a mobile device can be deployed in the operator compartment 119 of harvester 101 for use in generating, processing, or displaying the position and settings data. FIGS. 8-10 are examples of handheld or mobile devices.

FIG. 8 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication through one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and nonvolatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

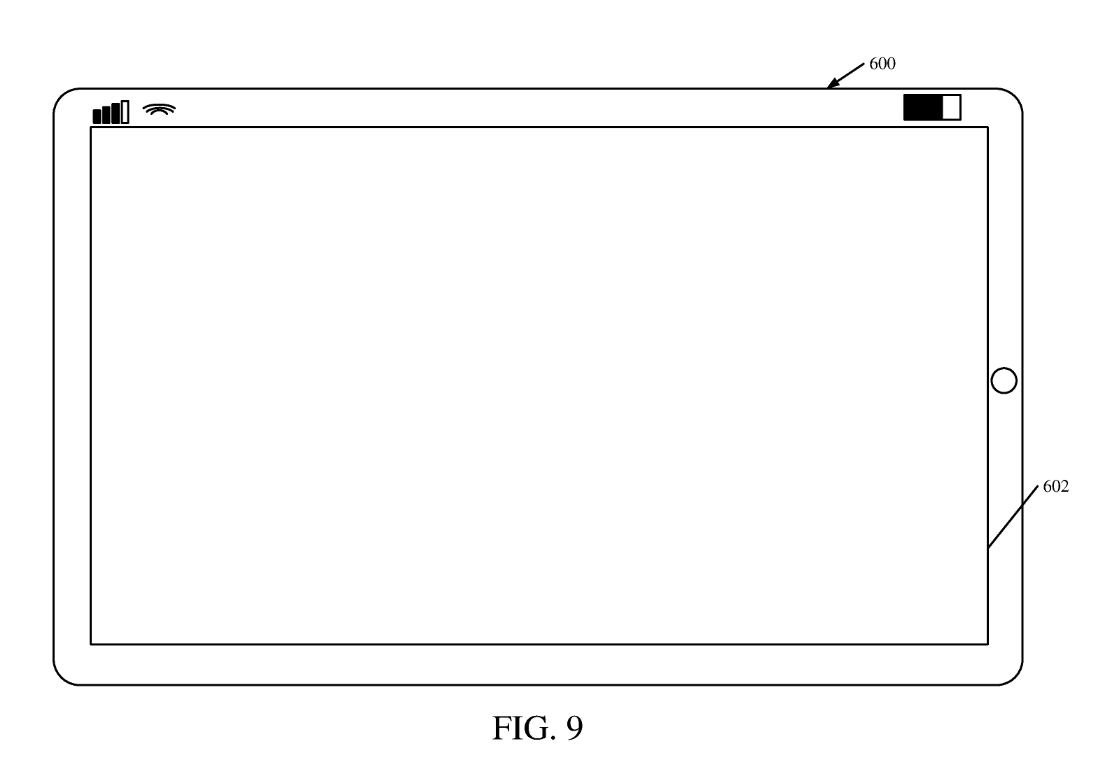

FIG. 9 shows one example in which device 16 is a tablet computer 600. In FIG. 9, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

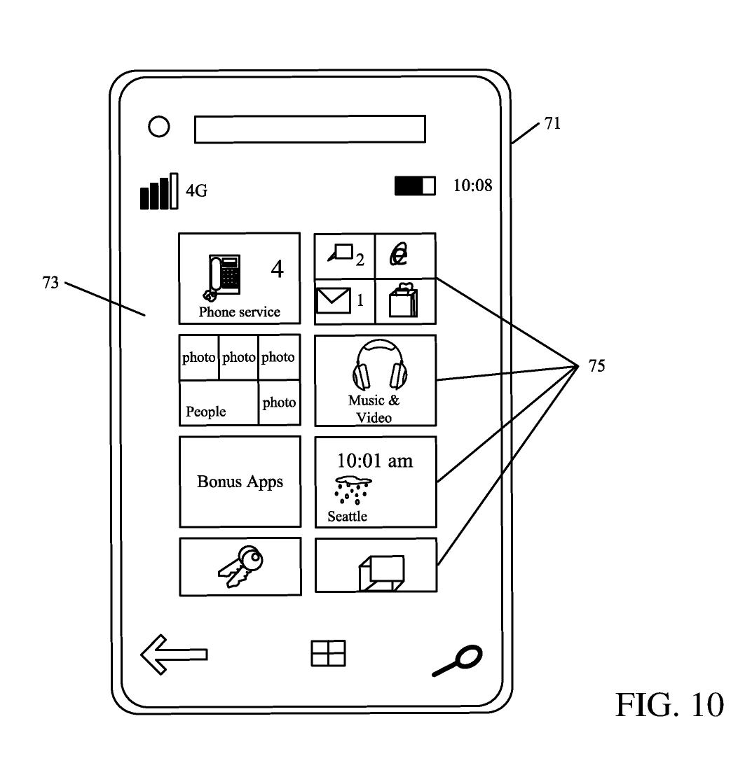

FIG. 10 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

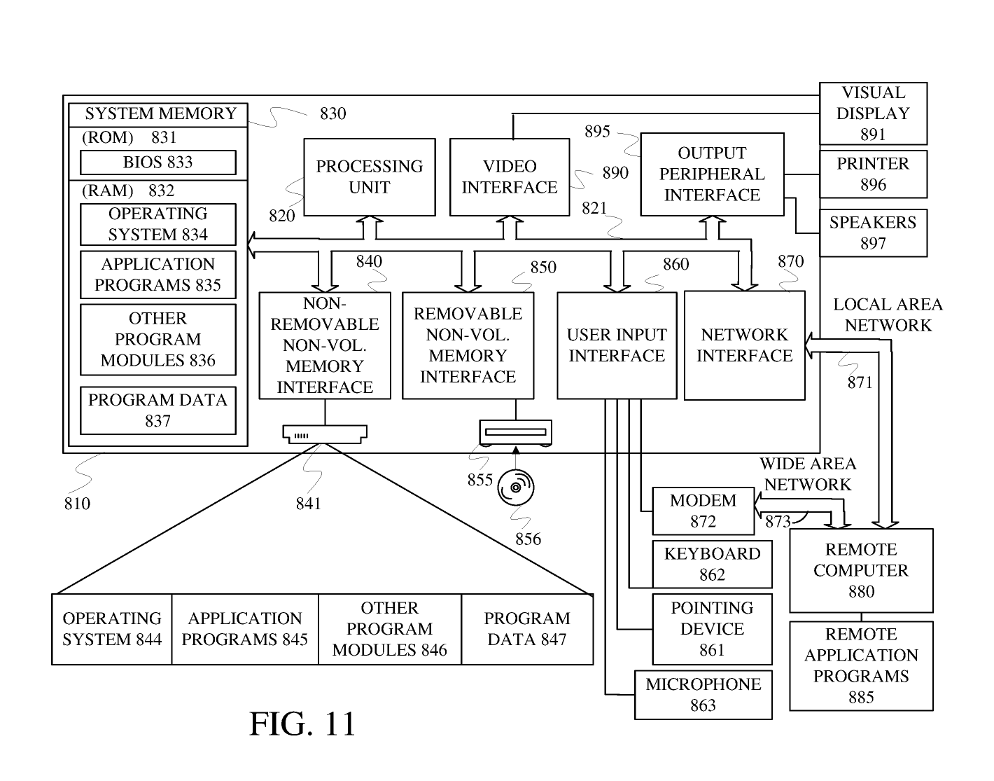

FIG. 11 is one example of a computing environment in which elements of previous FIGS., or parts of it, (for example) can be deployed. With reference to FIG. 11, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read-only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limited to, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network – CAN, local area network - LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 11 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method comprising:
detecting an area ahead of an agricultural harvester in a direction of travel during a harvesting operation;
locating a boundary of a passable non-crop area in the detected area; and
generating a control signal to control the agricultural harvester in response to the agricultural harvester traversing the boundary of the passable non-crop area.

2. The computer implemented method of claim 1, wherein detecting the area ahead of the agricultural harvester comprises:
capturing an image of the detected area.

3. The computer implemented method of claim 2, wherein locating the boundary comprises:
performing image processing on the image of the detected area to identify the passable non-crop area and the boundary of the non-crop area.

4. The computer implemented method of claim 1, wherein detecting the area ahead of the agricultural harvester comprises:
accessing a map of a field that includes the non-crop area; and
detecting a location and a heading of the agricultural harvester, and
wherein detecting the area ahead of the agricultural harvester in the direction of travel during the harvesting operation includes detecting the area ahead of the agricultural harvester based on the map and based on the location and the heading of the agricultural harvester.

5. The computer implemented method of claim 4, wherein locating a boundary comprises:
locating the boundary of the passable non-crop area based on the map and the location and the heading of the agricultural harvester.

6. The computer implemented method of claim 1, wherein generating the control signal comprises:
accessing a control settings value corresponding to the passable non-crop area; and
generating the control signal to control the agricultural harvester based on the control settings value corresponding to the passable non-crop area.

7. The computer implemented method of claim 6, wherein accessing the control settings value comprises:
identifying a type of the passable non-crop area; and
identifying the control settings value based on the type of the passable non-crop area.

8. The computer implemented method of claim 6, wherein accessing the control settings value comprises:
accessing a speed control value indicative of a target ground speed corresponding to the passable non-crop area, and
wherein generating the control signal comprises generating the control signal to control a propulsion subsystem of the agricultural harvester to propel the agricultural harvester at the target ground speed while the agricultural harvester is traversing the passable non-crop area.

9. The computer implemented method of claim 6, wherein the agricultural harvester includes a header,
wherein accessing the control settings value comprises:
accessing a header height control value indicative of a target header height corresponding to the passable non-crop area, and
wherein generating the control signal comprises generating the control signal to control a header position actuator to position the header at the target header height while the agricultural harvester is traversing the passable non-crop area.

10. The computer implemented method of claim 1, wherein locating the boundary comprises:
locating an entry boundary of the passable non-crop area.

11. The computer implemented method of claim 1, wherein locating the boundary comprises:
locating an exit boundary of the passable non-crop area.

12. A control system comprising:
a processing system configured to receive a sensor signal and detect a passable non-crop area ahead of an agricultural harvester in a direction of travel during a harvesting operation based on the sensor signal;
a non-crop area processor configured to generate an output signal indicative of a location of the passable non-crop area; and
a control signal generator configured to generate a control signal to control the agricultural harvester, based on the output signal, when the agricultural harvester is traveling in the passable non-crop area.

13. The control system of claim 12, further comprising:
a machine work point processing system configured to detect when a work point on the agricultural harvester is in the passable non-crop area based on the output signal.

14. The control system of claim 12, further comprising a perception sensor configured to capture an image ahead of the agricultural harvester in the direction of travel, and wherein the processing system comprises:
a perception sensor processing system configured to identify the passable non-crop area in the image.

15. The control system of claim 12, further comprising a position sensor configured to detect a location of the agricultural harvester, and
wherein the processing system comprises:
a location processing system configured to access a map of a field that includes the non-crop area and detect the area ahead of the agricultural harvester based on the map and based on the location of the agricultural harvester.

16. The control system of claim 12, wherein the non-crop area processor comprises:
a boundary identification system configured to locate a boundary of the passable non-crop area and generate a boundary identifier indicative of the location of the boundary, the control signal generator configured to generate the control signal based on the boundary identifier.

17. The control system of claim 12, wherein the control signal generator comprises:
a settings identification system configured to access a speed control value indicative of a target ground speed corresponding to the passable non-crop area; and
a speed control processor configured to generate the control signal to control a propulsion subsystem of the agricultural harvester to propel the agricultural harvester at the target ground speed while the agricultural harvester is traversing the passable non-crop area.

18. The control system of claim 12, wherein the control signal generator comprises:
a settings identification system configured to access a header control value indicative of a target header height corresponding to the passable non-crop area; and
a control processor configured to generate the control signal to control a header position actuator on the agricultural harvester to move the header to the target header height while the agricultural harvester is traversing the passable non-crop area.

19. An agricultural system comprising:
a processing system configured to receive a sensor signal and detect a passable non-crop area ahead of an agricultural harvester in a direction of travel during a harvesting operation based on the sensor signal; and
a control system configured to access a setting value corresponding to the passable non-crop area and generate a control signal to control the agricultural harvester with the setting value when the agricultural harvester is traveling in the passable non-crop area.

20. The agricultural system of claim 19, further comprising:
a perception sensor configured to capture an image of an area ahead of the agricultural harvester in the direction of travel and generate the sensor signal based on the captured image.
